(19) United States
(12) Patent Application Publication
(10) Pub. No.: US 2025/0373424 A1
(43) Pub. Date: Dec. 4, 2025

(54) End-To-End Encryption of Keystrokes for Virtual Applications and Desktops

(71) Applicant: Citrix Systems, Inc., Fort Lauderdale, FL (US)

(72) Inventors: Siddheshwar Kamatar, Bangalore (IN); Vikram Bhagwat, Bangalore (IN); Rajah Yoghindra K S, Bangalore (IN); Zaid Merchant, Bangalore (IN); Dinesh Jidugu, Bangalore (IN); Santosh Sampath, Bangalore (IN)

(21) Appl. No.: 18/731,887

(22) Filed: Jun. 3, 2024

(51) Int. Cl. H04L 9/08; G06F 3/023

(52) U.S. Cl. CPC H04L 9/088; G06F 3/023

(57) ABSTRACT

A computing system may receive, during a virtual desktop session, a keyboard input. The computing system may encrypt, using a keyboard encryption driver configured with an encryption mechanism, the keyboard input. The computing system may identify, based on the keyboard input, a transmission path for the encrypted keyboard input between the keyboard encryption driver and a virtual desktop host server. The computing system may transmit, via the identified transmission path and to the virtual desktop host server, the encrypted keyboard input, which may be decrypted by the virtual desktop host server using a decryption mechanism corresponding to the encryption mechanism, and passed to a virtual desktop application.

### FIELD

Aspects described herein generally relate to computer networking, remote computer access, virtualization, enterprise mobility management, and hardware and software related thereto. More specifically, one or more aspects described herein provide a method for end-to-end encryption of keystrokes between a client device and virtual applications/desktops.

### BACKGROUND

Keyloggers are a common type of malware that have existed for many years. Such keyloggers work silently to record and send keystrokes back to an attacker that deployed the malware. Despite its lengthy existence, keylogging (or keystroke logging) remains an effective method for collecting and sending confidential information such as usernames, passwords, or the like, to malicious actors. This type of malware may be particularly dangerous since it may operate without the knowledge of the owner of the compromised device.

Keystrokes are further susceptible to application level attacks such as code injection, hooking, or the like. This may occur because the keystrokes are decrypted at the client itself, even though they are actually required only at a virtual desktop application.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

With such widespread use of personal devices for work, the risk of keylogging malware and/or other attacks remains constant. Accordingly, aspects described herein protect sensitive applications from the threat of keylogging on both managed and unmanaged devices.

To overcome limitations in the prior art described above, and to overcome other limitations that will be apparent upon reading and understanding the present specification, aspects described herein are directed towards end-to-end encryption of keystrokes for virtual applications and desktops.

In one or more instances, a computing system may include one or more processors and memory storing computer executable instructions that, when executed by the processors cause the computing system to receive, at a client device and during a virtual desktop session, a keyboard input. The computing system may encrypt, using a keyboard encryption driver configured with an encryption mechanism, the keyboard input. The computing system may identify, based on the keyboard input, a transmission path for the encrypted keyboard input between the keyboard encryption driver and a virtual desktop host server. The computing system may transmit, via the identified transmission path and to the virtual desktop host server, the encrypted keyboard input, where the virtual desktop host server may be configured to: decrypt the encrypted keyboard input using a decryption mechanism corresponding to the encryption mechanism, and pass the decrypted keyboard input to a virtual desktop application.

In one or more examples, the encryption mechanism may include an encryption and keystroke substitution cipher. In one or more examples, the encryption and keystroke substitution cipher (KSC) may be dynamically updated, and the encryption and keystroke substitution cipher may be synchronized between the client device and the virtual desktop host server upon completion of each update.

In one or more instances, the encryption mechanism may include a symmetric encryption key (SEK). In one or more instances, the client device and the virtual desktop host server may be both configured with the symmetric encryption key.

In one or more examples, a type of encryption corresponding to the encryption mechanism may be selected based on the keyboard input. In one or more examples, the transmission path may include a remote desktop protocol engine used to configure the virtual desktop session.

In one or more instances, the transmission path may be selected to avoid distribution of the encrypted keyboard input to a remote desktop protocol engine used to configure the virtual desktop session. In one or more instances, the encrypted keyboard input may be sent between the client device and the virtual desktop host server via a keyboard virtual channel, established between the client device and the virtual desktop host server.

In one or more examples, the keyboard input may be received via a dedicated hardware keyboard.

In one or more examples, the encryption mechanism may include a first portion of the encryption mechanism configured to encrypt and decrypt a first portion of the keyboard input and a second portion of the encryption mechanism configured to encrypt and decrypt a second portion of the keyboard input. In one or more examples, decrypting the encrypted keyboard input may include: decrypting, for the virtual desktop application, the first portion of the keyboard input, and decrypting, for a different virtual desktop application, the second portion of the keyboard input.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIGS. 5A-5C depict an illustrative computing environment for implementing end-to-end encryption of keystrokes for virtual applications and desktops in accordance with one or more illustrative aspects described herein.

FIGS. 6A-6C depict an illustrative event sequence for performing end-to-end encryption of keystrokes for virtual applications and desktops in accordance with one or more illustrative aspects described herein.

FIGS. 7 and 8 depict illustrative methods for performing end-to-end encryption of keystrokes for virtual applications and desktops in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards facilitating end-to-end encryption of keystrokes for virtual applications and desktops. For example, as is described further below, the keylogging and/or other application level keystroke attacks may be prevented using such end-to-end encryption. Whereas current solutions may encrypt keystrokes in a kernel space and decrypt them in the user space at the user's workstation and then transport them to a virtual desktop application, in the proposed solution, such keystrokes are not decrypted at the user's workstation, but rather are transported (in encrypted form) to the VDA. At the VDA, these keystrokes may be decrypted and consumed by a virtual desktop or application. Such keystrokes are really needed at the VDA rather than the user's workstation, and thus, as described herein, the use of end-to-end encryption of keystrokes may make the transmission of such keystrokes less susceptible to attacks.

For example, current mechanisms may implement a simple key substitution algorithm for encryption, and breaking it may expose protected virtual applications and desktop sessions to keyloggers. Additionally, in the current anti-keylogging mechanism encryption may happen at the lowest level on the driver side and decryption may happen on the highest level on the application side. In these instances, a rogue user may attack the client in several possible ways. For example, an attacker may hook a lower level OS API and this API may be called eventually with decrypted keystrokes. The attacker may thus be able to get the keystrokes. If there is a malicious kernal driver component that hooks the user space APIs before the driver, the driver may call the malicious hooks with the decrypted keystrokes, and an attacker may be able to get the keystrokes. In addition, if an attacker becomes a part of a remote desktop application through injection or other means, it may be easy for them to inspect the decrypted keystrokes if the attackers routine exists before the remote desktop routine as part of a hook chain. Furthermore, if an attacker has the ability to unhook user level hooks, which may result in the unavailability of normal keyboard functionality (e.g., denial of service). As a result, it may be important to further enhance application protection features as described herein.

For example, rather than decrypting keystrokes at the client side, as described herein, decryption may be performed on the server side so no other processes in the client may decrypt the keystrokes intended for a virtual application or desktop session without having a secret key. For example, if plain decrypted keys are available on the client side, then at some point of time these may be prone to an attack by a keylogger. Any VDA may be running in a controlled environment, so there may be comparatively less chance of a keylogger. Accordingly, decryption on the server side may solve the problem.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

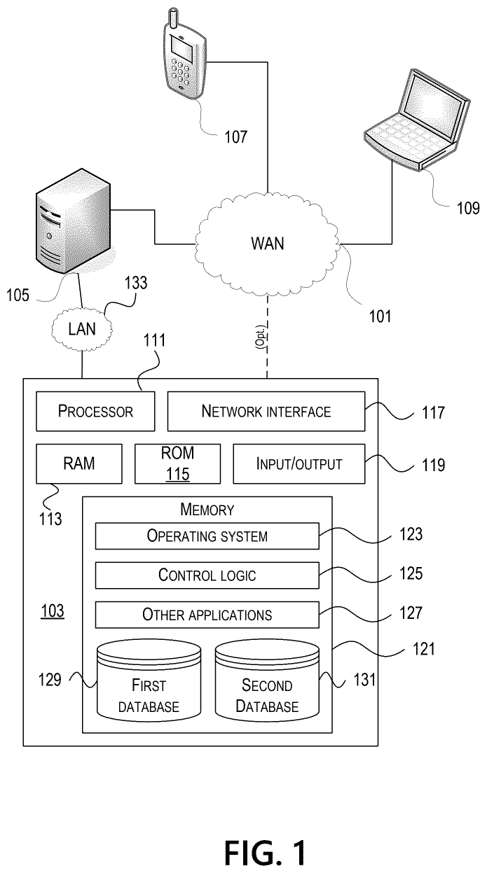

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

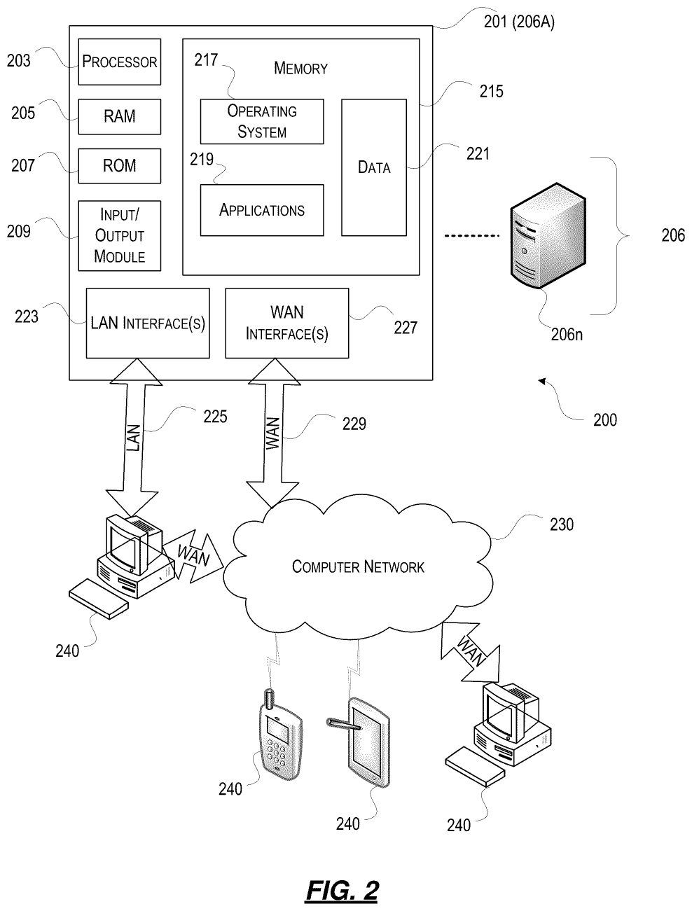

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine;

server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

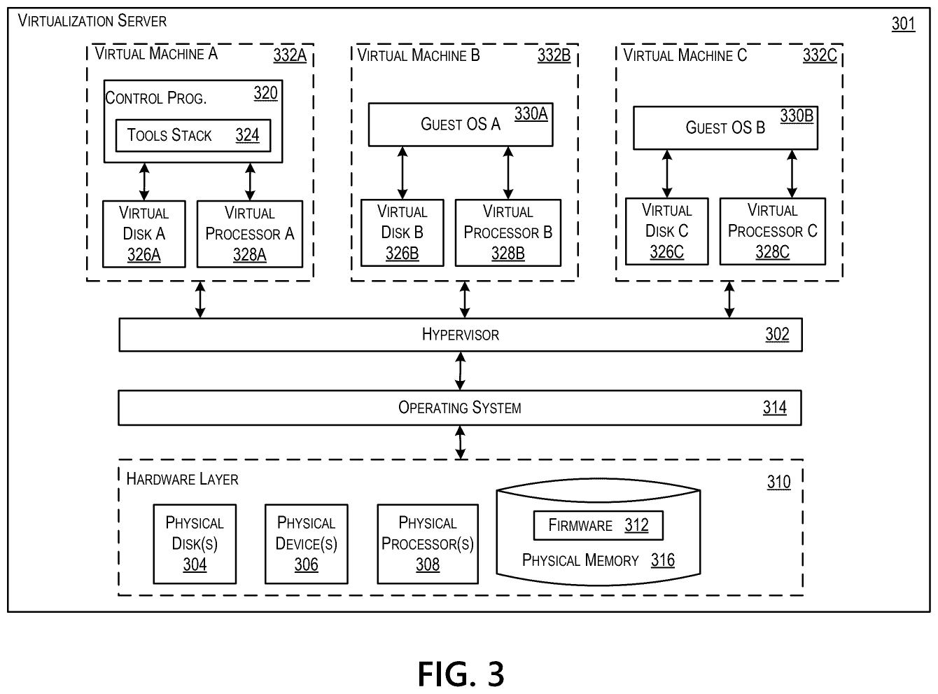

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

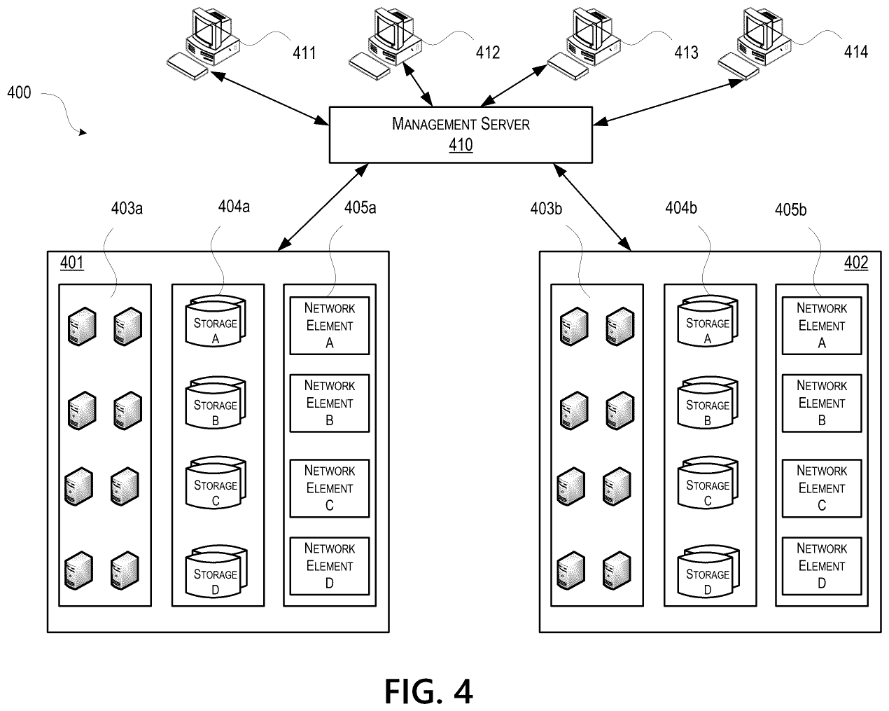

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### End-to-End Encryption of Keystrokes for Virtual Applications and Desktops

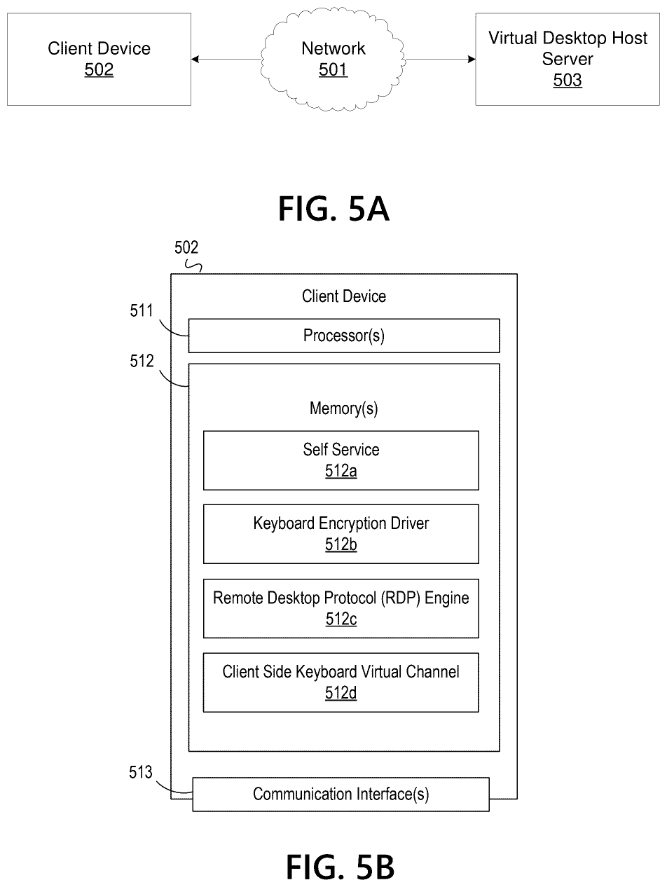

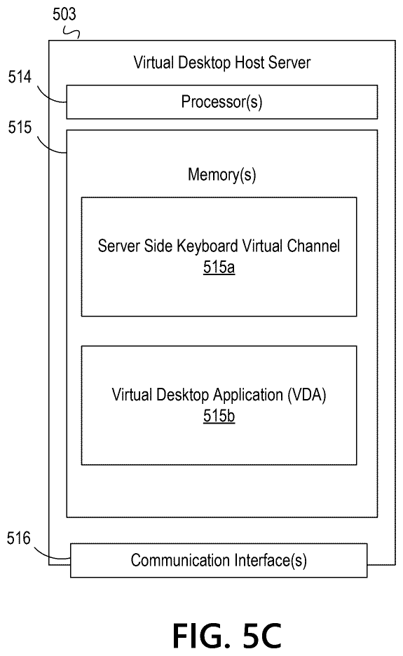

FIGS. 5A-5C depict an illustrative computing environment for providing end-to-end encryption of keystrokes for virtual applications and desktops in accordance with one or more illustrative aspects described herein. Referring to FIG. 5A, computing environment 400 may include one or more computer systems. For example, computing environment 400 may include a client device 502 and a virtual desktop host server 503.

As illustrated in greater detail below, client device 502 may be a personal computing device such as a smartphone, tablet, laptop computer, desktop computer, or the like. In some instances, client device 502 may be configured for management by a third party organization (e.g., using mobile device management), and may in some instances store enterprise, personal, and/or other data that is confidential or otherwise protected. In some instances, client device 502 may be configured to facilitate the use of virtual desktops, virtual applications, or the like. Although a single client device is depicted, any number of such devices may be implemented in the methods described herein without departing from the scope of the disclosure.

Virtual desktop host server 503 may be a computer system that includes one or more computing devices (e.g., servers, server blades, or the like) and/or other computer components (e.g., processors, memories, communication interfaces). In one or more instances, virtual desktop host server 503 may be configured to host one or more virtual desktop applications and/or other virtual applications, and may be configured to communicate with one or more client devices (e.g., client device 502) to facilitate the use of such applications.

Computing environment 400 may also include one or more networks, which may interconnect client device 502 and virtual desktop host server 503. For example, computing environment 400 may include a wired or wireless network 501 (which may e.g., interconnect client device 502 and virtual desktop host server 503).

In one or more arrangements, client device 502, virtual desktop host server 503, and/or the other systems included in the computing environment may be any type of computing device capable of receiving a user interface, receiving input via the user interface, and communicating the received input to one or more other computing devices. For example, client device 502, virtual desktop host server 503, and/or the other systems included in the computing environment may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of client device 502 and virtual desktop host server 503 may, in some instances, be special purpose computing devices configured to perform specific functions.

Referring to FIG. 5B, client device 502 may include one or more processors 511, memory 512, and communication interface 513. A data bus may interconnect processor 511, memory 512, and communication interface 513. Communication interface 513 may be a network interface configured to support communication between the client device 502 and one or more networks (e.g., network 501, or the like). Memory 512 may include one or more program modules having instructions that when executed by processor 511 cause client device 502 to perform one or more functions described herein and/or access one or more databases that may store and/or otherwise maintain information which may be used by such program modules and/or processor 511. In some instances, the one or more program modules and/or databases may be stored by and/or maintained in different memory units of client device 502 and/or by different computing devices that may form and/or otherwise make up client device 502. For example, memory 512 may have, host, store, and/or include instructions that direct and/or otherwise cause client device 502 to facilitate end-to-end encryption of keystrokes. For example, the client device 502 may store and/or otherwise include self service 512a, keyboard encryption driver 512b, remote desktop protocol (RDP) engine 512c, and client side keyboard virtual channel 512d. Self service 512a may facilitate the launch or remote and/or virtual desktop sessions based on requests received at the client device 502. Keyboard encryption driver 512b may provide one or more encryption mechanisms for the encryption of key strokes. RDP engine 512c may establish a remote and/or other virtual session at the client device 502. Client side keyboard virtual channel 512d may facilitate communication between the client device 502 and the virtual desktop host server 503.

Referring to FIG. 5C, virtual desktop host server 503 may include one or more processors 514, memory 515, and communication interface 516. A data bus may interconnect processor 514, memory 515, and communication interface 516. Communication interface 516 may be a network interface configured to support communication between the virtual desktop host server 503 and one or more networks (e.g., network 501, or the like). Memory 515 may include one or more program modules having instructions that when executed by processor 514 cause virtual desktop host server 503 to perform one or more functions described herein and/or access one or more databases that may store and/or otherwise maintain information which may be used by such program modules and/or processor 514. In some instances, the one or more program modules and/or databases may be stored by and/or maintained in different memory units of virtual desktop host server 503 and/or by different computing devices that may form and/or otherwise make up virtual desktop host server 503. For example, memory 515 may have, host, store, and/or include instructions that direct and/or otherwise cause virtual desktop host server 503 to facilitate end-to-end encryption of keystrokes. For example, the virtual desktop host server 503 may store and/or otherwise include server side keyboard virtual channel 515a and virtual desktop application (VDA) 515b. Server side keyboard virtual channel 515a may facilitate communication between the client device 502 and the virtual desktop host server 503. VDA 515b may facilitate the execution of one or more virtual desktop and/or other virtual applications.

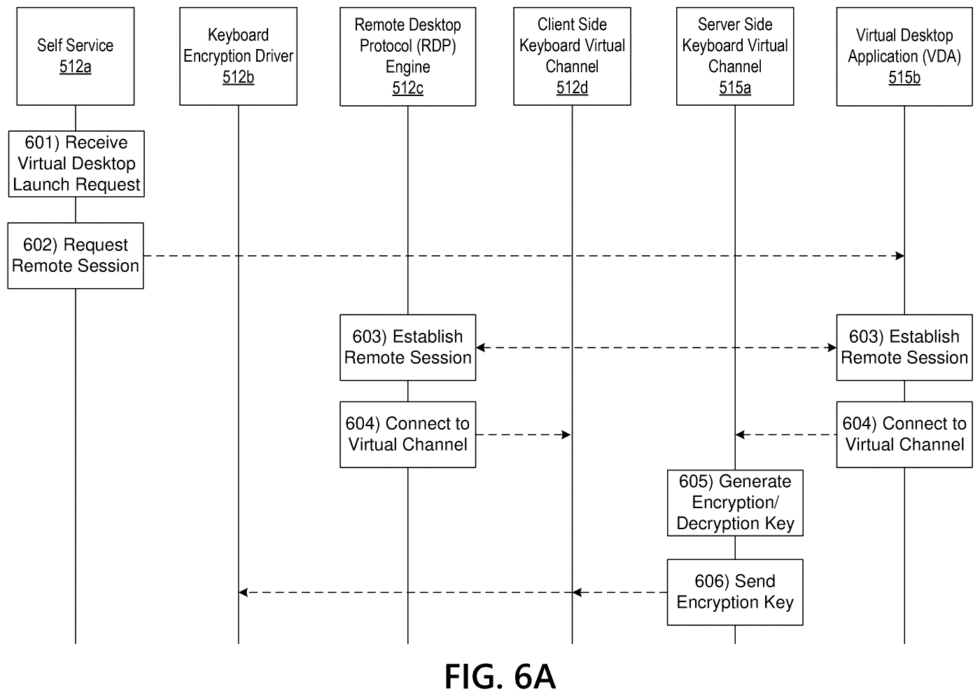

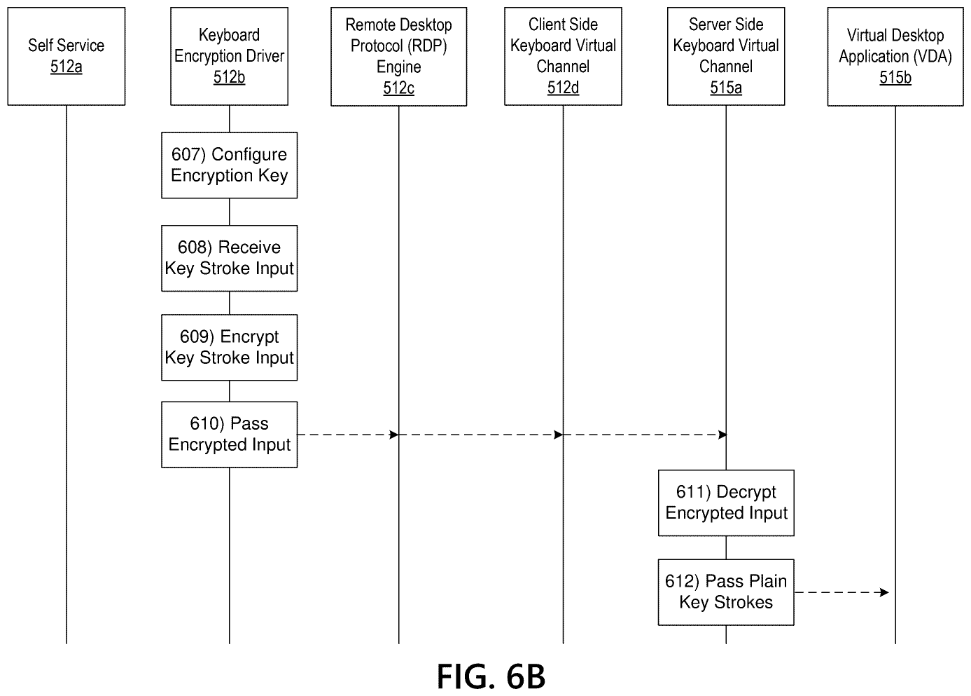

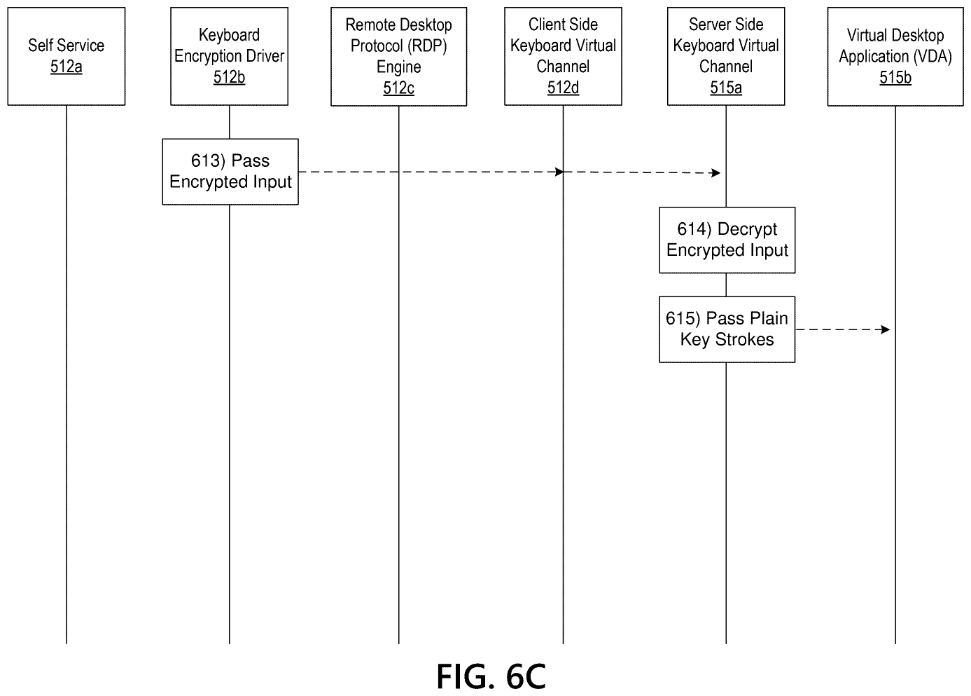

FIGS. 6A-6C depict an illustrative event sequence for providing end-to-end encryption of keystrokes for virtual applications and desktops in accordance with one or more illustrative aspects described herein. For convenience, steps 601-617 are shown across FIGS. 6A-6C. However, it should be understood that steps 601-617 represent a single event sequence (e.g., step 607 in FIG. 6B may follow step 606 in FIG. 6A)

Referring to FIG. 6A, at step 601, the user device 501 may receive (e.g., at the self service 512a) a virtual desktop launch request. For example, a user may input a request (e.g., via a graphical user interface of the user device 501, or the like) to launch a virtual desktop and/or other remote session. For example, the user may attempt to launch a virtual resource through a remote desktop application, or the like.

At step 602, the user device 501 may request the virtual desktop and/or other remote session from the virtual desktop host system 503. For example, the user device 501 may use the self service 512a to request the virtual desktop and/or other remote session from the VDA 515b of the virtual desktop host system 503. In some instances, while waiting for the virtual desktop and/or other remote session to be established, the user device 501 may launch an instance of a remote desktop protocol engine, such as RDP engine 512c. For example, RDP engine 512c may support ICA protocol (e.g., developed by Citrix Systems, Inc. of Ft. Lauderdale, Florida) and/or other remote desktop protocols to facilitate end-to-end encryption.

At step 603, virtual desktop host system 503 may communicate with the user device 501 to establish the virtual desktop and/or other remote session. For example, the VDA 515b of the virtual desktop host system 503 may communicate with the RDP engine 512c of the user device 501 to establish the virtual desktop and/or other remote session. In some instances, once the session is established at the VDA 515b, the RDP engine 512c and the VDA 515b may exchange virtual channel capabilities.

At step 604, the RDP engine 512c and VDA 515b may establish and connect to the virtual channel (e.g., based on the virtual channel capabilities exchanged at step 603). For example, the virtual channel may be established between a client side keyboard virtual channel 512d (at the client device 501) and a server side keyboard virtual channel 515a (at the virtual desktop host system 503). In these instances, the RDP engine 512c may connect to the client side keyboard virtual channel 512d and the VDA 515b may connect to the server side keyboard virtual channel 515a. In some instances, the keyboard virtual channel may be managed by a keyboard virtual channel service.

At step 605, the virtual desktop host system 503 may use the server side keyboard virtual channel 515a to generate an encryption mechanism. For example, the keyboard virtual channel service may create encryption and decryption keys using a keystroke substitution cipher (KSC). In some instances, in this KSC, different keys may be dynamically substituted (e.g., rotating through which keys have not yet been substituted rather than consistently substituting one key for another). In some instances, as the KSC is dynamically updated, it may be synchronized between the client device and the virtual desktop host server upon completion of the update. Additionally or alternatively, the keyboard virtual channel service may generate a public/private key pair.

At step 606, the virtual desktop host system 503 may send the encryption mechanism, generated at step 605, to the user device 501. For example, the encryption key may be sent between the server and client sides of the keyboard virtual channel (e.g., client side keyboard virtual channel 512d and server side keyboard virtual channel 515a), and on to the keyboard encryption driver 512b. In some instances, the keyboard virtual channel service may synchronize the KSC between the virtual desktop host system 503 and the client device 501. Additionally or alternatively, the virtual desktop host system 503 may share the public key.

Referring to FIG. 6B, at step 607, the keyboard encryption driver 512b may register the encryption mechanism received at step 606. For example, the keyboard encryption driver 512b may configure the encryption mechanism for use at the client device 501 (e.g., for encrypting keystrokes as described below). For example, the keyboard encryption driver 512b may synchronize with the KSC provided at step 606. Additionally or alternatively, the keyboard encryption driver 512b may generate a symmetric encryption key (SEK), and encrypt it using the public key. In these instances, the encrypted SEK may be provided to the RDP engine 512c, which may, e.g., provide the encrypted SEK to the keyboard virtual channel service of the virtual desktop host system 503 via the virtual channel (which may, e.g., store the SEK). After completing steps 601-607, the key exchange mechanism may be completed for the purpose of providing an improved anti-keylogging mechanism, the performance of which is described further below.

At step 608, the keyboard encryption driver 512b may receive a key stroke input. For example, the user put input one or more key strokes during a virtual session, and the keyboard encryption driver 512b may be informed accordingly. In some instances, the keyboard encryption driver 512b may be notified when an anti-keylogging policy is enabled. In some instances, the anti-keylogging policy may be disabled, and the keyboard encryption driver 512b might not be notified of the keystrokes accordingly. In some instances, the one or more keystrokes may be received via a virtual keyboard, dedicated hardware keyboard, and/or other keyboard. In these instances where a dedicated hardware keyboard is implemented, the keyboard may have a custom driver that may conceal inputs from keyloggers. For example, such keyloggers would merely detect encrypted traffic from the keyboard, which might not be distinguishable as a keyboard input.

At step 609, the keyboard encryption driver 512b may encrypt the key stroke input. For example, the keyboard encryption driver 512b may use the encryption mechanism (registered in the keyboard encryption driver 512b at step 607) to encrypt the key stroke input. For example, in some instances, the encryption may be performed using the KSC, the SEK, and/or other mechanisms.

By using such methods of encryption rather than a simple key substitution algorithm, the encryption may be robust against attacks attempting to break the encryption, thus protecting against exposure of virtual applications, desktop sessions, or the like to keyloggers.

In some instances, the keyboard encryption driver 512b may identify a transmission path for the encrypted key stroke input (e.g., based on content of the encrypted key stroke input, or the like). For example, the keyboard encryption driver 512b may identify the transmission path based on a level of encryption needed for the corresponding key strokes. For example, where advanced encryption schemes are necessary, a larger payload (e.g., when compared to less intensive encryption schemes) may be generated and formatting of the encrypted key stroke input may vary. In instances where such advanced encryption schemes are used, where payload exceeds a predetermined threshold, where formatting of the encrypted keystrokes may vary, and/or in other such instances, the keyboard encryption driver 512b may identify that the encrypted key stroke input should be sent directly into the keyboard virtual channel (e.g., without passing through the RDP engine 512c). In some instances, the level of encryption may be identified based on contents of the key stroke input. For example, where the key stroke input indicates a hotkey functionality, and/or other non-sensitive information, less encryption may be implemented (and thus the transmission path described in steps 610-612 may be selected). For example, the keyboard encryption driver 512b may maintain a lookup table of known functions, and may compare the contents of the key stoke input against the lookup table to identify whether or not it is a match with a known function. In these instances, the encrypted key stroke may be sent to the virtual desktop host system 503 via the RDP engine 512c. Alternatively, more encryption may be implemented where more sensitive information, such as a password, username, or the like is identified. In some instances, such sensitive information may be identified based on a known entry field, a randomized input detection, and/or other methods. In these instances, the encrypted key stroke may be sent directly to the virtual desktop host system 503. If the keyboard encryption driver 512b identifies that the encrypted key stroke input should be sent to the virtual desktop host system 503 via the RDP engine 512c, the keyboard encryption driver 512b may proceed to step 610. Otherwise, if the keyboard encryption driver 512b identifies that the encrypted key stroke input should be sent directly to the virtual desktop host system 503 (e.g., without passing through the RDP engine 512c), the keyboard encryption driver 512b may proceed to step 613.

At step 610, the keyboard encryption driver 512b may pass the encrypted key stroke input to the virtual desktop host system 503. For example, the keyboard encryption driver 512b may pass the encrypted key stroke input via the RDP engine 512c and into the keyboard virtual channel (e.g., the client side keyboard virtual channel 512d). The encrypted key stroke input may then be passed through the virtual channel and to the virtual desktop host system 503 (e.g., received at the server side keyboard virtual channel 515a). For example, the encrypted key stroke input may be received at the keyboard virtual channel service.

In some instances, the RDP engine 512c may pass the encrypted key stroke input across the keyboard virtual channel in a standard format defined by the client device operating system. For example, the encrypted key stroke input may be formatted in the standard format and according to a fixed length.

By transporting these key stroke inputs in encrypted form (e.g., rather than decrypting the key stroke inputs at the client prior to such transmission), the keyboard encryption driver 512b may make them less susceptible to attack.

At step 611, the keyboard virtual service at the server side keyboard virtual channel 515a may decrypt the encrypted key stroke input using the decryption key generate at step 605. For example, the keyboard virtual service may decrypt the encrypted key stroke input using the KSC, the SEK, and/or other mechanism. By decrypting the key stroke input at the server side, no other processes in the client (which may, e.g., be prone to attacks by keyloggers) may decrypt the key stroke inputs intended for the VDA. The VDA 515b may be operating in a controlled environment, which may minimize chances of a keylogger operating therein. Accordingly, server side decryption may provide enhanced security for the key stroke inputs.

For example, such server side decryption may protect against attacks from rogue users such as hooking lower level OS APIs to obtain key stroke inputs, implementing a malicious driver component to hook the user space APIs before the driver to obtain key stroke inputs, using injection to inspect the key stroke inputs as part of a hook chain, unhooking user level hooks to cause denial of service, and/or other attacks.

At step 612, once the key stroke input is decrypted, the corresponding plain key strokes may be passed from the virtual channel to the VDA 515b. In some instances, the plain key strokes may be passed to a plurality of virtual desktop applications.

Returning to step 609, if the keyboard encryption driver 512b identified that the encrypted key stroke input should be passed directly to the virtual desktop host system 503, the keyboard encryption driver 512b may have proceeded to step 613. Referring to FIG. 6C, at step 613, the keyboard encryption driver 512b may pass the encrypted key stroke input directly into the keyboard virtual channel (e.g., at the client side keyboard virtual channel 512d), and it may be received at the keyboard virtual channel service at the virtual desktop host system 503. In doing so, the encrypted key stroke input may bypass a standard mechanism, involving the use of operating system specific APIs, en route to the VDA 515b. As described above, selection of such a transmission path may, in some instances, offer security advantages over the transmission path described in steps 610-612.

At step 614, the keyboard virtual service at the server side keyboard virtual channel 515a may decrypt the encrypted key stroke input using the decryption key generate at step 605. For example, the keyboard virtual service may decrypt the encrypted key stroke input using the KSC, SEK, and/or other decryption mechanism. As described above at step 611, by performing such decryption at the server side rather than on the client, security of the key stroke input may be enhanced.

At step 615, once the key stroke input is decrypted, the corresponding plain key strokes may be passed from the virtual channel to the VDA 515b. In some instances, the plain key strokes may be passed to a plurality of virtual desktop applications.

In some instances, the methods described above with regard to steps 601-615 may be applied to any remote connection solution (virtual applications, remote desktops, virtual network computing, secure shell, and/or other solutions), remote browser execution scenario, or the like without departing from the scope of the disclosure to secure the corresponding keyboard traffic.

Furthermore, such methods may be applied to multi hop scenarios (e.g., connections to a first virtual application, and then a second virtual application, or the like). For example, in such scenarios, the intermediate hops need not decrypt keystrokes in some instances. In some instances, different encryption/decryption mechanisms may be shared with each instance, thus enabling them to decrypt different portions of the encrypted key stroke inputs as needed. In some instances, a first layer of decryption may be performed to reveal a decrypted portion of the key stroke inputs along with an encrypted portion of the key stroke inputs. In these instances, the decrypted portion of the key stroke inputs may be visible to the initial application, and the encrypted portion of the key stroke inputs may be decrypted at a subsequent application, or the like. For example, this may be due to different access permissions and/or security policies at various nodes along the transmission path.

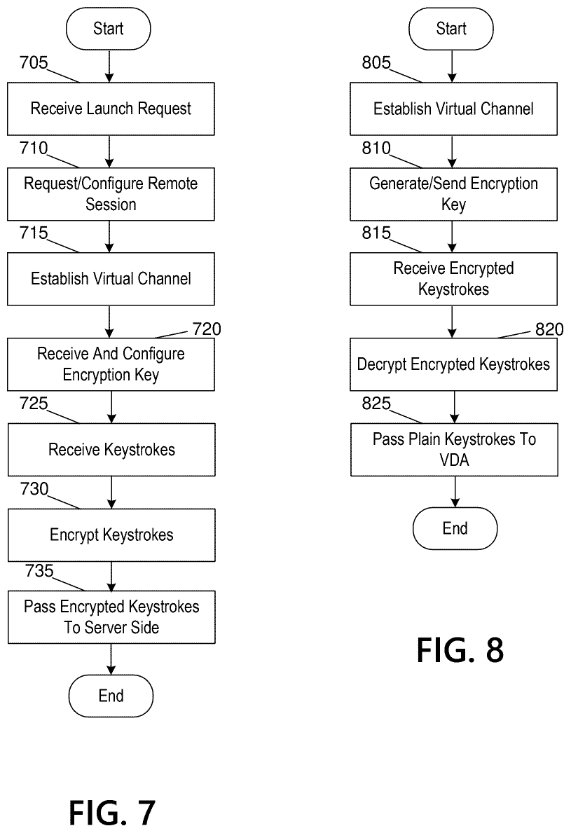

FIG. 7 depicts an illustrative method for providing end-to-end encryption of keystrokes for virtual applications and desktops in accordance with one or more illustrative aspects described herein. At step 705, a computing device comprising one or more processors, a communication interface, and memory may receive a virtual desktop and/or other virtual application launch request. At step 710, the computing device may configure the virtual desktop and/or remote application session. At step 715, the computing device may establish a virtual channel connecting the computing device to a virtual desktop host platform. At step 720, the computing device may receive an encryption key from the virtual desktop host platform and may configure the encryption key for use in encrypting keystrokes. At step 725, the computing device may receive keystrokes through a virtual application. At step 730, the computing device may encrypt the keystrokes using the encryption key. At step 735, the computing device may pass the keystrokes through the virtual channel to the virtual desktop host platform.

While FIG. 7 describes end-to-end encryption of keystrokes for virtual applications and desktops from a perspective of the client device, FIG. 8 (described below) describes such encryption from a perspective of a remote desktop host platform.

FIG. 8 depicts an illustrative method for providing end-to-end encryption of keystrokes for virtual applications and desktops in accordance with one or more illustrative aspects described herein. At step 805, a computing device comprising one or more processors, a communication interface, and memory may establish a virtual channel connecting the computing device to a client device. At step 810, the computing device may generate an encryption key and send the encryption key to a client device. At step 815, the computing device may receive encrypted keystrokes from the client device. At step 820, the computing device may decrypt the encrypted keystrokes. At step 825, the computing device may pass the plain keystrokes to a VDA. The following paragraphs (M1) through (M12) describe examples of methods that may be implemented in accordance with the present disclosure.

(M1) A method comprising receiving, at a client device and during a virtual desktop session, a keyboard input; encrypting, using a keyboard encryption driver configured with an encryption mechanism, the keyboard input; identifying, based on the keyboard input, a transmission path for the encrypted keyboard input between the keyboard encryption driver and a virtual desktop host server; and transmitting, via the identified transmission path and to the virtual desktop host server, the encrypted keyboard input, wherein the virtual desktop host server is configured to: decrypt the encrypted keyboard input using a decryption mechanism corresponding to the encryption mechanism, and pass the decrypted keyboard input to a virtual desktop application.

(M2) A method may be performed as described in paragraph (M1) wherein the encryption mechanism comprises an encryption and keystroke substitution cipher.

(M3) A method may be performed as described in paragraph (M2) wherein the encryption and keystroke substitution cipher (KSC) is dynamically updated, and wherein the encryption and keystroke substitution cipher is synchronized between the client device and the virtual desktop host server upon completion of each update.

(M4) A method may be performed as described in any of paragraphs (M1) through (M3) wherein the encryption mechanism comprises a symmetric encryption key (SEK).

(M5) A method may be performed as described in paragraph (M4), wherein the client device and the virtual desktop host server are both configured with the symmetric encryption key.

(M6) A method may be performed as described in any of paragraphs (M1) through (M5) wherein a type of encryption corresponding to the encryption mechanism is selected based on the keyboard input.

(M7) A method may be performed as described in any of paragraphs (M1) through (M6) wherein the transmission path includes a remote desktop protocol engine used to configure the virtual desktop session.

(M8) A method may be performed as described in any of paragraphs (M1) through (M7) wherein the transmission path is selected to avoid distribution of the encrypted keyboard input to a remote desktop protocol engine used to configure the virtual desktop session.

(M9) A method may be performed as described in any of paragraphs (M1) through (M8) wherein the encrypted keyboard input is sent between the client device and the virtual desktop host server via a keyboard virtual channel, established between the client device and the virtual desktop host server.

(M10) A method may be performed as described in any of paragraphs (M1) through (M9) wherein the keyboard input is received via a dedicated hardware keyboard.

(M11) A method may be performed as described in any of paragraphs (M1) through (M10) wherein the encryption mechanism includes a first portion of the encryption mechanism configured to encrypt and decrypt a first portion of the keyboard input and a second portion of the encryption mechanism configured to encrypt and decrypt a second portion of the keyboard input.

(M12) A method may be performed as described in paragraph (M11) wherein decrypting the encrypted keyboard input comprises: decrypting, for the virtual desktop application, the first portion of the keyboard input, and decrypting, for a different virtual desktop application, the second portion of the keyboard input.

The following paragraphs (A1) through (A7) describe examples of apparatuses that may be implemented in accordance with the present disclosure.

(A1) A computing system comprising one or more processors; memory storing computer executable instructions that, when executed by the processor, cause the computing system to: receive, during a virtual desktop session, a keyboard input; encrypt, using a keyboard encryption driver configured with an encryption mechanism, the keyboard input; identify, based on the keyboard input, a transmission path for the encrypted keyboard input between the keyboard encryption driver and a virtual desktop host server; and transmit, via the identified transmission path and to the virtual desktop host server, the encrypted keyboard input, wherein the virtual desktop host server is configured to: decrypt the encrypted keyboard input using a decryption mechanism corresponding to the encryption mechanism, and pass the decrypted keyboard input to a virtual desktop application.

(A2) The computing system according to paragraph (A1) wherein the encryption mechanism comprises an encryption and keystroke substitution cipher.

(A3) The computing system according to paragraph (A2) wherein the encryption and keystroke substitution cipher (KSC) is dynamically updated, and wherein the encryption and keystroke substitution cipher is synchronized between the computing system and the virtual desktop host server upon completion of each update.

(A4) The computing system according to any of paragraphs (A1) through (A3) wherein the encryption mechanism comprises a symmetric encryption key (SEK).

(A5) The computing system according to paragraph (A4) wherein the computing system and the virtual desktop host server are both configured with the symmetric encryption key.

(A6) The computing system according to any of paragraphs (A1) through (A5) wherein a type of encryption corresponding to the encryption mechanism is selected based on the keyboard input.

(A7) The computing system according to any of paragraphs (A1) through (A6) wherein the transmission path includes a remote desktop protocol engine used to configure the virtual desktop session.

The following paragraph (CRM1) describes an example of computer-readable media that may be implemented in accordance with the present disclosure.

(CRM1) A non-transitory computer-readable medium storing instructions that, when executed, cause a system to: receive, at a client device and during a virtual desktop session, a keyboard input; encrypt, using a keyboard encryption driver configured with an encryption mechanism, the keyboard input; identify, based on the keyboard input, a transmission path for the encrypted keyboard input between the keyboard encryption driver and a virtual desktop host server; and transmit, via the identified transmission path and to the virtual desktop host server, the encrypted keyboard input, wherein the virtual desktop host server is configured to: decrypt the encrypted keyboard input using a decryption mechanism corresponding to the encryption mechanism, and pass the decrypted keyboard input to a virtual desktop application.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, at a client device and during a virtual desktop session, a keyboard input;
encrypting, using a keyboard encryption driver configured with an encryption mechanism, the keyboard input;
identifying, based on the keyboard input, a transmission path for the encrypted keyboard input between the keyboard encryption driver and a virtual desktop host server; and
transmitting, via the identified transmission path and to the virtual desktop host server, the encrypted keyboard input, wherein the virtual desktop host server is configured to:
decrypt the encrypted keyboard input using a decryption mechanism corresponding to the encryption mechanism, and
pass the decrypted keyboard input to a virtual desktop application.

2. The method of claim 1, wherein the encryption mechanism comprises an encryption and keystroke substitution cipher.

3. The method of claim 2, wherein the encryption and keystroke substitution cipher (KSC) is dynamically updated, and wherein the encryption and keystroke substitution cipher is synchronized between the client device and the virtual desktop host server upon completion of each update.

4. The method of claim 1, wherein the encryption mechanism comprises a symmetric encryption key (SEK).

5. The method of claim 4, wherein the client device and the virtual desktop host server are both configured with the symmetric encryption key.

6. The method of claim 1, wherein a type of encryption corresponding to the encryption mechanism is selected based on the keyboard input.

7. The method of claim 1, wherein the transmission path includes a remote desktop protocol engine used to configure the virtual desktop session.

8. The method of claim 1, wherein the transmission path is selected to avoid distribution of the encrypted keyboard input to a remote desktop protocol engine used to configure the virtual desktop session.

9. The method of claim 1, wherein the encrypted keyboard input is sent between the client device and the virtual desktop host server via a keyboard virtual channel, established between the client device and the virtual desktop host server.

10. The method of claim 1, wherein the keyboard input is received via a dedicated hardware keyboard.

11. The method of claim 1, wherein the encryption mechanism includes a first portion of the encryption mechanism configured to encrypt and decrypt a first portion of the keyboard input and a second portion of the encryption mechanism configured to encrypt and decrypt a second portion of the keyboard input.

12. The method of claim 11, wherein decrypting the encrypted keyboard input comprises:
decrypting, for the virtual desktop application, the first portion of the keyboard input, and
decrypting, for a different virtual desktop application, the second portion of the keyboard input.

13. A computing system comprising:
one or more processors;
memory storing computer executable instructions that, when executed by the processor, cause the computing system to:
receive, during a virtual desktop session, a keyboard input;
encrypt, using a keyboard encryption driver configured with an encryption mechanism, the keyboard input;
identify, based on the keyboard input, a transmission path for the encrypted keyboard input between the keyboard encryption driver and a virtual desktop host server; and
transmit, via the identified transmission path and to the virtual desktop host server, the encrypted keyboard input, wherein the virtual desktop host server is configured to:
decrypt the encrypted keyboard input using a decryption mechanism corresponding to the encryption mechanism, and
pass the decrypted keyboard input to a virtual desktop application.

14. The computing system of claim 13, wherein the encryption mechanism comprises an encryption and keystroke substitution cipher.

15. The computing system of claim 14, wherein the encryption and keystroke substitution cipher (KSC) is dynamically updated, and wherein the encryption and keystroke substitution cipher is synchronized between the computing system and the virtual desktop host server upon completion of each update.

16. The computing system of claim 13, wherein the encryption mechanism comprises a symmetric encryption key (SEK).

17. The computing system of claim 16, wherein the computing system and the virtual desktop host server are both configured with the symmetric encryption key.

18. The computing system of claim 13, wherein a type of encryption corresponding to the encryption mechanism is selected based on the keyboard input.

19. The computing system of claim 13, wherein the transmission path includes a remote desktop protocol engine used to configure the virtual desktop session.

20. One or more non-transitory computer-readable media storing instructions that, when executed by a computing system comprising at least one processor, a communication interface, and memory, cause the computing system to:
receive, at a client device and during a virtual desktop session, a keyboard input;
encrypt, using a keyboard encryption driver configured with an encryption mechanism, the keyboard input;
identify, based on the keyboard input, a transmission path for the encrypted keyboard input between the keyboard encryption driver and a virtual desktop host server; and
transmit, via the identified transmission path and to the virtual desktop host server, the encrypted keyboard input, wherein the virtual desktop host server is configured to:
decrypt the encrypted keyboard input using a decryption mechanism corresponding to the encryption mechanism, and
pass the decrypted keyboard input to a virtual desktop application.
